(19) United States
(12) Patent Application Publication
(10) Pub. No.: US 2005/0170099 A1
(43) Pub. Date: Aug. 4, 2005

(54) Method and device for internal coating of cavities by thermal spraying

(76) Inventors: Rainer Gadow, Aschau am Inn (DE); Andreas Killinger, Filderstadt-Bernhausen (DE); Michael Buchmann, Kissing (DE); Daniel Lopez Martinez, Stuttgart (DE)

Correspondence Address: HARNESS, DICKEY & PIERCE, P.L.C., P.O. BOX 828, BLOOMFIELD HILLS, MI, 48303, US

(21) Appl. No.: 11/022,076

(22) Filed: Dec. 23, 2004

Related U.S. Application Data
(63) Continuation of application No. PCT/EP03/06736, filed on Jun. 26, 2003.

(30) Foreign Application Priority Data
Jul. 4, 2002 (DE) 102 30 847 .0-45

(51) Int. Cl. B05D 1/08; B23B 3/34

(52) U.S. Cl. 427/446

(57) ABSTRACT

The invention describes a device and a method for internal coating of cavities of workpieces by thermal spraying, comprising a burner for spraying a coating material, the burner being received on a positioning device for allowing positioning at least in one direction, and further comprising a rotary plate, which can be driven in rotary fashion and on which is provided a workpiece holder for a workpiece that can be positioned relative to the burner by means of a guiding device. The guiding device comprises at least one first linear guide with a first drive means for positioning the workpiece holder, and at least one second linear guide with a second drive means for positioning a balancing weight. The first and the second drive means are driven in opposite senses, which guarantees continuous balancing of the masses when the workpiece is displaced. In order to ensure continuous evacuation of overspray, the rotary plate is provided, in the area of its axis of rotation, with an opening to which an exhaust system can be connected.

### RELATED APPLICATIONS

This is a continuation application of copending International Patent Application PCT/EP03/06737 which claims priority of German patent application 102 30 847.3 filed on Jul. 4, 2002.

### BACKGROUND OF THE INVENTION

The present invention relates to a device for internal coating of rotationally symmetrical, in particular cylindrical cavities of workpieces by thermal spraying, comprising a burner for spraying a coating material, the burner being received on a positioning device for allowing positioning at least in one direction, and further comprising a rotary support, especially a rotary plate, which can be driven in rotary fashion and on which is provided a workpiece holder for a workpiece that can be positioned relative to the burner by means of a guiding device.

The present invention further relates to a method for internal coating of rotationally symmetrical, in particular cylindrical cavities on workpieces by thermal spraying using a burner to which a spray material is supplied, wherein the burner is retained on a positioning device and the workpiece is moved to rotate relative to the burner.

A device and a method of that kind have been disclosed by M. Buchmann et al., “Solid lubricant containing coatings for cylinder liners in pressure casted aluminum crankcase”, Proceedings of the 1^{st} International Thermal Spray Conference, May 8 to 11, 2000, Montreal, pp. 303-308.

According to that publication, the burner is retained in stationary fashion on a positioning device while the workpiece is mounted on a rotationally driven rotary plate.

This arrangement provides advantages over the devices commonly used in the prior art, with stationary workpiece and rotating burner, which normally are advanced into the cavity of the workpiece to be coated in timed manner, as for example in linear transfer lines. All in all it is thus possible to work with a larger working distance, whereby a larger possible expansion of the burner spray jet is obtained, allowing a more uniform coating surface to be achieved. Further, it is possible to work with higher spray jet speeds which clearly improves the quality of the coating.

However, the before-mentioned publication does not disclose the exact structure of the device required to achieve safe and trouble-free coating of even larger workpieces, for example when coating cylinder bores or liners of crankcases for light-metal engines.

Further reference is made to U.S. 2001/0054654 A1 to Miyai et al. which disclose a thermal spraying system for coating an inner surface of a cylinder. Miyai et al. teach to use a central hole in a turntable used for supporting the cylinder to be coated. The central hole may be connected to a suction device for removing overspray.

### SUMMARY OF THE INVENTION

It is a first object of the invention to disclose a device and a method for thermal spray coating of inner surfaces of workpieces providing for a safe and trouble-free coating of internal surfaces, even if larger workpieces have to be coated.

It is a second object of the invention to disclose a device and a method for thermal spray coating of inner surfaces of workpieces that are adapted for coating large workpieces in a series production.

It is a third object of the invention to disclose a device and a method for thermal spray coating of inner surfaces of workpieces allowing for a particularly high-quality coating adapted for application in an internal combustion engine.

These and other objects are achieved, with a device of the type described above, by an arrangement in which the guiding device comprises at least one linear guiding device arranged in radial direction on the rotary support for positioning the workpiece holder.

Preferably, the linear guiding device comprises a first linear drive and a second linear drive that are coupled so as to move in opposite directions

The object of the invention is further achieved, with a method of the kind described above, by an arrangement where any unbalance caused by some movement of the workpiece is balanced out by moving at least one balancing weight.

According to one aspect of the invention any unbalance caused by the necessary process of centering the cavity to be coated relative to the burner is balanced out by a balancing weight. In this way, even workpieces with greater mass and irregular shape, such as crankcases of piston engines, can be set into rotation on the rotary plate at a sufficiently high speed without any problems arising due to unbalances of the mass. Given the fact that any unbalance caused by the rotary plate can always be automatically balanced out by the balancing weight so that the rotary plate can be balanced relative to its axis of rotation, a high degree of safety is guaranteed even at high rotary speeds of the rotary plate. And by having any disadvantageous influences of mass unbalances balanced out, any vibrations or similar disadvantages are likewise avoided so that high balance quality can be guaranteed even at high rotary speeds, with the effect that especially high uniformity of the coating can be achieved. In the case of coatings of cylinder liners of light-metal crankcase housings, for example, a single smoothing after-treatment, for example by honing, is required whereas no dimensional after-treatments, such as cutting or grinding operations in complex fixtures or devices, will be required.

According to the invention, it is possible to coat numerous cavities in succession, even in a series production process, without any negative influences due to overspray, or any undesirable depositions caused thereby.

According to a preferred further development of the invention, the workpiece holder is retained on two mutually parallel first linear guides, with two second linear guides, each provided with a balancing weight, being arranged in parallel to the two outer sides of the first linear guides.

The two balancing weights preferably are equal in size and are each arranged at the same distance from the first linear guides and, preferably, can be moved and positioning almost infinitely.

It is thus possible to safely balance even heavy workpieces with respect to the axis of rotation of the rotary plate, with a resulting simple structure of the device.

According to another feature of the invention, the first and the second drive means comprise drive spindles, preferably self-locking drive spindles, preferably self-locking trapezoidal spindles.

This feature provides the advantage that a high degree of reliability is ensured by the use of drive spindles, especially self-locking trapezoidal spindles, in centering the cavity to be coating relative to the axis of rotation of the rotary plate. Further, a high degree of safety is ensured that the workpiece or the balancing weights will not move independently, even at high speeds of rotation.

According to a further embodiment of the invention the two drive spindles are driven by a common drive via a worm gear.

The worm gear may be coupled in this case with the two first drive spindles via at least one corner gear.

It is thus possible to have both drive spindles driven in a simple way by a common drive.

According to an additional further development of the invention, the first and the second drive spindles are coupled via corner gears for being driven in opposite senses.

In this way, driving the first and the second drive spindles in opposite senses can be achieved by especially simple means.

According to a further embodiment of the invention, there is provided a battery-powered DC drive, which is coupled with the drive means for common operation.

In this way, an especially simple structure is achieved. Alternatively, a line-powered drive, supplied with voltage via wiper contacts, may be provided for commonly driving the drive means.

According to a further embodiment of the invention, limit switches are provided on the ends of the linear guides.

This contributes to further increasing safety as in case the workpiece of the balancing weights should get displaced and move up to the limit switches, the device can be stopped automatically.

It is possible in this way to achieve especially dense, high-quality coatings with good bonding effect. Since it is possible in this way to work with a relatively large spray distance and high kinetic energy of the particle spray jet, up to velocities in the supersonic speed range, one thereby further achieves greater expansion of the spray jet and ultimately improved uniformity, higher density and improved bonding of the coating.

According to another aspect of the invention the burner is moved by a positioning device along an elliptic path relative to the inner workpiece surface to be treated. The impact angle (Φ) between the axis of the burner and the internal surface may preferably be varied between approximately 90° and approximately 10°, more preferably between approximately 90° and approximately 20°.

This allows an especially uniform coating to be achieved over the circumference and height of the component.

According to a further embodiment of the invention, there is provided in addition to the burner, at least one cooling lance for cooling the workpiece with compressed air or CO₂.

So very good and homogeneous cooling can be ensured during the coating process, especially when CO₂ is used. This on the one hand prevents overheating problems in the case of very temperature-sensitive workpieces or thin wall thicknesses of the basic material or the workpieces, such as light-metal crankcases, while on the other hand negative influences of thermal stresses in the coating are avoided or even optimized process control, in terms of transition of heat and material, is rendered possible during the coating process.

According to a further embodiment of the invention, the workpiece holder comprises a tilting device adapted to tilt the workpiece relative to the burner axis and to realize a combined rotary and tilting movement according to the angular position of the bores in in-line engines, opposed cylinder engines, V-type and W-type engines, or a preferably automatic turning device adapted to turn the workpiece by 180°. Under control aspects, these devices can be integrated by means of NC processes and using stored-program control means that are part of the overall coating system.

In this way, even crankcases for V-type engines can be coated automatically in a simple way. On the other hand, coating is rendered possible also for workpieces where part of the cavities are to be coated from one side while another part of the cavities are to be coated from the opposite side.

If a HVOF burner is used, the impact angle (Φ) is varied preferably between a maximum angle, in the range of approximately 90°, in the TDC area of the respective cavity, and an angle that decreases as the depth of the cavity increases.

In coating the cylinder liners of crankcases it is then possible to use a maximum impact angle of nearly 90° at the upper end of the respective cavity, with the effect that the coating material strikes the internal surface to be coated with maximum energy so that optimum quality and density of the coating can be achieved in the area that will be subjected to maximum load when the respective cylinder liner or crankcase is used in an internal combustion engine.

Preferably, the rate of feed of the burner is controlled approximately in proportion to the impact angle Φ in this case.

This has the result that the reduced coating thickness resulting from the reduced impact angle is balanced out by the rotational speed, which is then also reduced, so that in the outcome a uniform coating thickness is obtained over the entire depth of the cavity.

Preferably, the burner is continuously operated during the coating process and is retracted or turned away from the workpiece only when coating a plurality of workpieces in succession.

It is possible in this way, due to the continuous operation of the burner, to achieve an especially favorable and time-saving process control.

When using a HVOF burner, a spray distance of approximately 150 to 500 mm, preferably of approximately 150 to 400 mm, is preferably maintained relative to the surface of the workpiece to be coated.

The rotary plate is preferably driven at approximately 40 to 100 r.p.m. in this case.

Spray parameters of that kind permit coatings of especially high quality to be achieved.

Alternatively, coating can be effected by atmospheric plasma spraying (APS) or electric arc spraying, preferably by means of internal burners using a 90° angle burner.

In this case, a spray distance of approximately 25 to 600 mm is preferably maintained between the internal surface of the cavity to be coated and the burner.

The rotary plate is preferably driven at approximately 80 to 200 r.p.m. in this case.

Advantageous coatings can be obtained also by atmospheric plasma spraying.

Given the fact that a stationary burner is used in this case as well, especially a burner with an angle head which is advanced into the cavity to be coated, such process control allows a higher spray jet speed than conventional spray methods using a rotating burner and a stationary workpiece.

Advantageous coatings, suited for light-metal crankcases, are obtained especially when TiO₂ is used as spray material, as in this case TiO₂₋ₓ layers are obtained which have very low coefficients of friction under dry friction conditions, in addition to low wear rates.

In case a HVOF burner is used, the coating process advantageously can be run as an external coating process with the burner located outside the cylindrical cavity of the respective bores, which normally is tightly sized in the case of passenger-car engines. This then allows a relatively large spray distance to be used, which contributes toward achieving uniform coatings. In addition, coating of cavities with internal diameters of <50 mm is rendered possible in this way.

### BRIEF DESCRIPTION OF THE DRAWINGS

It is understood that the features of the invention mentioned above and those yet to be explained below can be used not only in the respective combinations indicated, but also in other combinations or in isolation, without leaving the scope of the present invention. Other features and advantages of the invention will become apparent from certain preferred embodiments of the invention which will be described hereafter with reference to the drawings which are of merely explanatory design not limiting the scope of the invention and in which:

FIG. 1 shows a diagrammatic representation of a first embodiment of the device according to the invention;

FIG. 2 shows a diagrammatic representation, illustrating the variation of the spray angle when the burner is moved along an elliptic path for coating the internal surface of a bore; and

FIG. 3 shows a simplified perspective view of the rotary plate of a device according to the invention, slightly modified relative to the embodiment illustrated in FIG. 1.

### DETAILED DESCRIPTION OF THE PREFERRED EMBODIMENTS

FIG. 1 shows a diagrammatic representation of a first embodiment of a device according to the invention, indicated generally by reference numeral 10.

Inside a spray booth 12 of sound-proofed design there can be seen a rotary plate 14 seated by its outer circumference in a roller bearing on a table, for rotation about an axis of rotation 16. The rotary plate can be driven by a drive 18 via a belt 20. Mounted on the rotary plate 14 is a guide means, indicated generally by reference numeral 32, by means of which a workpiece holder 40 can be reciprocated in radial direction of the rotary plate 14. The workpiece holder 40 is provided with a fixture, not shown in detail, for mounting a workpiece 34 indicated by a dash-dotted line in FIG. 1. A workpiece may, for example, consist of a light-metal crankshaft housing comprising a plurality of cylinder liners whose internal surfaces are to be coated.

In FIG. 1, a total of four cavities 36 of a light-metal crankshaft housing, whose internal surfaces are to be spray-coated, are indicated by dash-dotted lines.

The rotary plate 14 has an opening 17 at its center which serves to exhaust overspray. Beneath the rotary plate 14, an exhaust system 38 connected with a vacuum source 39 is indicated by dashed lines.

A HVOF burner 24 is received on a positioning device 22 designed as multi-axis robot. The burner 24 can be positioned relative to the workpiece 34 by means of the positioning device 22. Two cooling lances 28, 30, suited for radial emission of cooling gas, are arranged in parallel to the axis 26 of the burner 24 along which the spray jet of the burner is delivered. Although in principle compressed-air cooling would be sufficient, the cooling lances 28, 30 are configured in the present case as CO₂ cooling lances that achieve a clearly improved cooling effect. The high cooling effect of a CO₂ cooling process is due to sublimation of the CO₂ snow from the solid to a gaseous state of aggregation. A further advantage resides in the cleaning effect of non-fused overspray particles.

The guide means 32 comprises two mutually parallel first linear guides 42, 43 for displacement of the workpiece holder 40. There are further provided two second linear guides 44, 45, which are identical in structure to the first linear guides 42, 43 and which enclose the two first linear guides 42, 43 from the outside. Balancing weights 46, 47 are provided for displacement along the two linear guides 44, 45, respectively. The guide means 32 is driven by a battery-powered DC motor 52 that drives two 90° corner gears 56, 57 via a worm gear 54. The corner gears 56, 57 drive two self-locking trapezoidal spindles 48, 49 which in turn drive the workpiece holder 40 via spindle nuts not shown in the drawing. Each of the ends of the trapezoidal spindles 48, 49 opposite the corner gears 56, 57 is coupled with a trapezoidal spindle 50, 51 via a 180° corner gear 58, 59, respectively, through which the balancing weights 46, 67 are driven in synchronism via spindle nuts not shown in the drawing.

A limit switch 60, 61, 62, 63 or 64, 65, 66, 67, respectively is provided on the end of each linear guide 42, 43 or 44, 45, respectively.

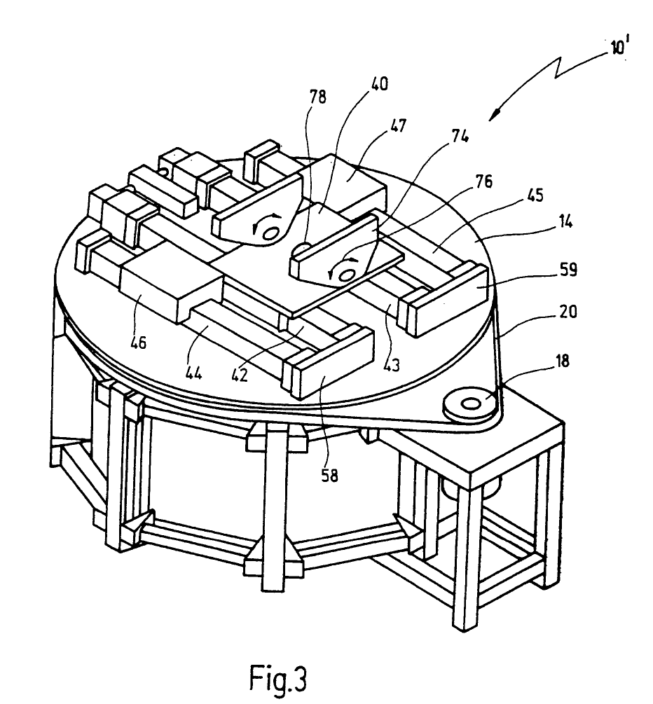

In FIG. 3, a slightly modified embodiment of the device according to the invention is indicated by reference numeral 10′.

The device 10′ largely corresponds in structure to the device according to FIG. 10. The workpiece holder 40 is, however, additionally provided with a tilting device indicated purely diagrammatically by reference numeral 74. The workpiece, for example a light-metal crankshaft housing, can be mounted on the tilting device and can then be tilted to the one or to the other side in the direction indicated by arrow 76. This is of advantage if crankshaft housings for V-type or W-type engines are to be coated.

Correspondingly, there may be provided a turning device for turning the workpiece by 180° if coating is to be effected, for example, on crankshaft housings that must be coated partly from the one side and partly from the other side (as, for example, for a six-cylinder engine for a Porsche Boxster).

The coating process will now be described in more detail.

Suited as coating processes are either atmospheric plasma spraying (APS) or electric arc spraying or high-velocity open flame spraying (HVOF) processes. Practical APS internal coating processes were carried out using a 90° angle burner type GTV F1. That burner has a maximum rating of 25 KW and a maximum spray distance of 600 mm. The coatable cavity depth was 500 mm max. During the internal coating process, the angle burner enters the rotating cavity in vertical direction. Due to the constructional details of the F1 angle burner, only cylinder bores with internal diameters of at least 80 mm can be coated technically. Thus, the spray distance achievable was equal to at least 30 mm.

The coating layers are applied upon the rotating workpiece while the F1 plasma burner is advanced in vertical direction. The rotational speed of the cavity was varied between 80 and 200 r.p.m., depending on the spray distance and the layer system to be applied. Although a two-axis feed system is sufficient for advancing the internal plasma burner in vertical direction, a positioning device 22 in the form of a multi-axis robot was used in the illustrated case. The vertical rate of feed of the burner is in the range of 2 to 10 mm/s, depending on the layer system used. The number of burner passes depends on the particular spay material and the required layer thickness, and is between 2 and 10 passes. The smaller the spray distance between the burner and the substrate surface, the smaller is the expansion of the particle jet and the surface area coated. Consequently, high rotational speed is required for the workpiece, especially in the case of small spray distances, in order to obtain homogenous structures with acceptable surface quality. Simultaneously with the coating process, the internal surface of the workpiece is cooled.

Cooling can be effected with either air jet compressed-air cooling systems or using CO₂ cooling lances 28, 30, as has been described before.

In the case where the burner 24 was designed as HVOF burner, the TopGun® system marketed by GTV-mbH was used for internal coating. Due to variable combustion chamber inserts, this type of burner additionally provides the possibility to use acetylene as fuel gas with the effect that fuel gas temperatures of up to 3,200° Celsius can be reached. These temperatures are high enough to fuse even refractory materials such as MO and ZrO₂. Depending on the spray material used, the fuel/gas mixture and gas flow, it is possible to achieve spray distances of between approximately 150 mm and 500 mm with the HVOF burner 24. As a result of these large spray distances, the HVOF process can be run as external process, which means that the burner remains outside the cavity 36 of the workpiece 34 for the entire duration of the coating process. This external arrangement allows even bores with an internal diameter of less than 80 mm to be coated.

During the HVOF spray process, the burner 24 moves along an elliptic feed path. For coating crankshaft housings, the coating process is implemented in such a way that the TDC area of the cylinder bore, which is exposed to the highest thermal and mechanical stresses in operation, is coated at almost 90° while the cylinder areas exposed to lower stresses are coated at a decreasing impact angle Φ of the spray jet.

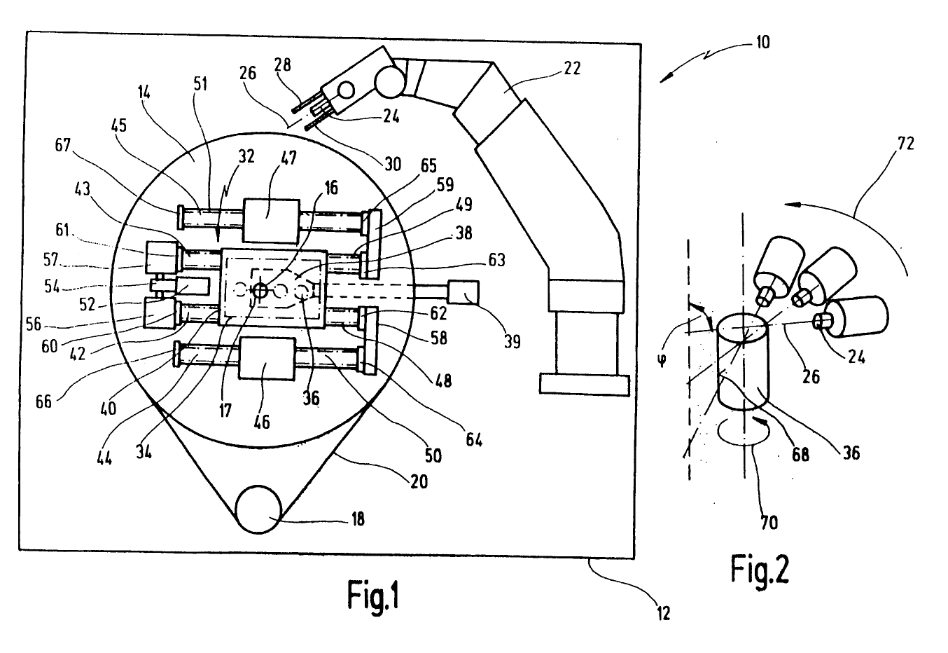

These conditions are indicated in FIG. 2.

In FIG. 2, a cavity 36 to be coated is shown in the form of a cylinder bore of the workpiece 34.

At the upper end of the bore or the cavity 36, the impact angle Φ between the longitudinal axis 26 of the burner 24 and the internal surface 36 is equal to approximately 90°. As the depth of the bore increases, the spray angle Φ becomes smaller until it reaches approximately 30° at the bottom of the bore.

By adapting the feed speed of the burner 24 to the impact angle Φ of the spray jet it is possible to obtain a homogeneous layer structure and layer thickness over the entire height of the internal surface 68 to be coated. For this purpose, the rate of feed is varied during the coating process in proportion to the impact angle between approximately 50 mm/s (impact angle Φ of approximately 90°) and 5 mm/s (impact angle Φ of approximately 30°).

Due to the complex kinematics of movement, a fully-automated seven-axis robot system marketed by Stäubli (positioning means 22) is used for the HVOF coating process. With the aid of the robot control it is possible to flexibly program the rotational speed of the rotary plate 14 (preferably between approximately 30-100 r.p.m.) and variable angles of impact Φ and spray distances, depending on the spray material selected and the fuel/gas mixture used.

The movement of the guide means 32, the driving speed of the rotary plate 14 and the movement of the burner 24 are all controlled in coordinated fashion by the robot control. In order to prevent the workpiece 34 from being excessively heated in a HVOF coating process, cooling by means of CO₂ cooling lances 24, 28 is preferred, especially when coating light-metal crankshaft housings.

For each cavity 36 of the workpiece 34 to be coated, the respective cavity 36 to be coated of the workpiece 34 is centered with respect to the axis of rotation 16 of the rotary plate 14, by corresponding actuation of the drive 56 and, thus, of the trapezoidal spindles 42, 43.

During movement to a different position, in which a further cavity 36 of the workpiece 34 is to be coated, the balancing weights 46, 47 move the same distance as the workpiece 34, but in opposite direction. This allows a balanced condition to be reached at any time, regardless of the radial position of the workpiece 34, when the workpiece is counterbalanced during the mounting process. Generally, the balancing weights 46, 47 and the workpiece 34 can be arranged in such a way that a balanced condition is obtained relative to the axis of rotation 16 during operation of the rotary plate 14, and will be maintained even when the workpiece 34 should be displaced as a result of relative movements of the balancing weights 46, 47.

As has been discussed before, an opening 16, through which overspray can be exhausted into the free space available below the rotary plate 14, is located in the central area of the rotary plate 14 in a position centered on the axis of rotation 16. During the coating process, the cavity 36 to be coated, which is open toward the bottom, is aligned with that opening 17 so that free escape of overspray is permitted toward the bottom with the result that negative influences of undesirable overspray on the coating process are avoided. As has been mentioned before, an exhaust system 38 may be additionally provided below the opening 18. It goes without saying that in this case the workpiece holder 40 must have at least one opening aligned with the opening 17 (compare opening 78 in FIG. 2), unless the workpiece holder is anyway provided with a larger central opening.

Prior to the coating process, the internal surface 36 to be coated is pre-treated with roughing jets, which process generally can be effected using corundum, cast steel or a method employing high-pressure water jets.

Tests were carried out on light-metal crankshaft housings, which were coated with a number of different layer systems. The hardness values (HV 0.05_{M}) or porosity characteristics (P_{M}) and the modules of elasticity (E_{M}) are summarized in tables 1a), 1b), 1c) for ceramic layer systems, cermet layer systems and metallic layer systems. Substrate materials suitable for light-metal crankshaft housings comprise all usual materials such as AlMg3, magnesium (AM50), titanium (Ti4) AlSi9Cu, AlSi17Cu4Mg3 (Alusil®) AlSi25 (Silitec®). In addition, crankcases made from cast iron and bushes of the same material may likewise be internally coated in dimensions up to the size of large diesel engines.

Coating tests using APS and HVOF were carried out on the substrate materials AlMg3, AM50, Ti4, AlSiCu9.

As can be seen, especially dense layers, which in addition show an especially good bonding effect, can be achieved by the HVOF coating process. The coefficients of friction and wear of the sprayed layers were studied under lubricated friction conditions and under dry friction conditions. The coefficients of wear for the layers so determined were so small that all spray materials tested, except for AlSi12, are suited for use as slideway materials.

Tests carried out with respect to the post-treatment of separate bushes coated with FeCr17, Cr₃C₂/NiCr-80/20 and TiO₂ have shown that these layer systems can be finish-treated using conventional resin-bonded diamond honing bands without any extra time. No dimensional after-treatment was required in view of the high uniformity of the spray layers of 0.1-0.2 mm thickness. Especially the HVOF layer systems have very small roughness values R_{A} of between 0.03 and 0.09 μm, due to their very low degree of layer porosity in the smoothly honed final condition.

Under dry friction conditions, the TiO₂₋ₓ layer systems, obtained by atmospheric plasma spraying of titanium dioxide, are of particular interest. In this case, very small coefficients of friction could be measured under dry friction conditions. Under lubricated conditions, all systems are suited, except for AlSi12.

Apart from applying thin layers in the order of approximately 0.1 to 0.2 mm, as in the present case on light-metal crankshaft housings, the described device and the described method (especially the HVOF method) are also suited for applying thick layers in the order of approximately 1 to 2 mm and also for local spray coating in preferred locations, i.e. in locations of the component that are subjected to especially high stresses in use.

TABLE 1a

| | HV0.05_{N}[N/mm²) | P_{M}[V %] | E_{N}[GPa] |
|---|---|---|---|
| TiO₂(APS) | 1250 | 3 | 198 |
| TiO₂(HVOF) | 1075 | 2 | 190 |
| Al₂O₃/TiO₂-60/40(APS) | 1580 | 4 | 215 |
| Al₂O₃/TiO₂-60/40(HVOF) | 1160 | 3 | 178 |
| Cr₂O₃/TiO₂-60/40(APS) | 1750 | 4 | 220 |
| Cr₂O₃/TiO₂-60/40/HVOF) | 1350 | 3 | 205 |
| Cr₂O₃(APS) | 2650 | 7 | 252 |
| Cr₂O₃(HVOF) | 2130 | 3 | 215 |

TABLE 1b

| | HV0.05_{N}[N/mm²) | P_{M}[V %] | E_{N}[GPa] |
|---|---|---|---|
| Cr₃C₂/NiCr-80/20(APS) | 1300 | 11 | 210 |
| Cr₃C₂/NiCr-80/20(HVOF) | 1560 | 8 | 223 |
| CrB/NiCr-75/25(APS) | 1100 | 12 | 230 |
| CrB/NiCr-75/25(HVOF) | 1170 | 10 | 240 |
| (Ti,Mo)(C,N)/Ni-80/20(APS) | 1050 | 9 | 175 |
| (Ti,Mo)(C,N)/Ni-80/ | 1130 | 4 | 180 |
| 20(HVOF) | | | |

TABLE 1c

| | | |
|---|---|---|
| HV0.05_{N}[N/mm²) | P_{M}[V %] | E_{N}[GPa] |

| | | | |
|---|---|---|---|
| Mo (APS) | 650 | 9 | 200 |
| Mo(HVOF) | 920 | 3 | 210 |
| FeCr17(APS) | 220 | 8 | 160 |
| FeCr17(HVOF) | 350 | 5 | 180 |
| Mo/FeCr17-70/30(APS) | 470 | 8 | 165 |
| Mo/FeCr17-70/30(HVOF) | 870 | 4 | 210 |
| AlSi12(APS) | 85 | 4 | 65 |
| AlSi12(HVOF) | 105 | 10 | 70 |

1-10. (canceled)

11. A method for coating an inner surface of a rotationally symmetric cavity of a workpiece by thermal spraying comprising the following steps:
clamping said workpiece on a workpiece holder arranged on a rotary support;
positioning a burner relative to said inner surface of said workpiece to be coated;
linearly positioning said workpiece holder along a linear guide arranged on said rotary support for balancing said rotary support with respect to its axis of rotation;
rotationally driving said rotary support; and
firing said burner for ejecting a flame of spray material impacting onto said inner surface of said workpiece.

12. The method of claim 11, wherein said workpiece holder is linearly positioned for aligning said cavity of said workpiece to be coated with said axis of rotation of said rotary support.

13. The method as defined in claim 11, wherein said workpiece comprises a plurality of rotationally symmetrical cavities to be coated, wherein for coating a plurality of cavities in succession, the workpiece is displaced linearly and any movement of the workpiece caused thereby is balanced out by moving at least one balancing weight.

14. A method for coating an inner surface of a rotationally symmetric cavity of a workpiece by thermal spraying comprising the following steps:
clamping said workpiece on a workpiece holder arranged on a rotary support in a position in which an upper end of said cavity faces a burner and a lower end of said cavity is remote from said burner;
rotationally driving said rotary support;
firing said burner for ejecting a flame of spray material impacting onto said inner surface of said workpiece at an impact angle defined between a longitudinal axis of said burner and said inner surface to be coated;
positioning a burner relative to said inner surface of said workpiece to be coated and selecting said impact angle depending on a distance between said burner and said upper end of said cavity.

15. The method of claim 14, wherein said impact angle is varied depending on a distance of said burner from said upper end of said workpiece.

16. The method as defined in claim 14, wherein said impact angle is varied between 90° and 10°.

17. A method for coating an inner surface of a rotationally symmetric cavity of a workpiece by thermal spraying comprising the following steps:
clamping said workpiece on a workpiece holder arranged on a rotary support;
rotationally driving said rotary support;
firing a burner for ejecting a flame of spray material impacting onto said inner surface of said workpiece; and
moving said burner along an elliptical path relative to said inner surface of said workpiece.

18. The method of defined in claim 17, wherein said workpiece cavity is a cavity of a combustion cylinder of an internal combustion engine having a TDC, wherein said impact angle is varied between a maximum angle occurring when said flame of spray material impacts in proximity to TDC, and a minimum angle occurring at some point when said flame of spray material is moved away from TDC.

19. The method as defined in claim 14, wherein a rate of feeding spray material to said burner is controlled so as to increase when said impact angle increases.

20. The method of claim 14, wherein said rate of feeding spray material to said burner is controlled substantially in proportion to said impact angle.

21. The method as defined in claim 11, wherein coating is effected by high-velocity spraying.

22. The method as defined in claim 11, wherein said burner is continuously operated during the coating process and is retracted or turned away from the workpiece only when coating a plurality of cavities of workpieces in succession.

23. The method as defined in claim 14, wherein coating is effected by high-velocity spraying.

24. The method as defined in claim 14, wherein said burner is continuously operated during the coating process and is retracted or turned away from the workpiece only when coating a plurality of cavities of workpieces in succession.

25. The method as defined in claim 17, wherein said burner is continuously operated during the coating process and is retracted or turned away from the workpiece only when coating a plurality of cavities of workpieces in succession.
